(19) United States
(12) Patent Application Publication
(10) Pub. No.: US 2020/0169678 A1
(43) Pub. Date: May 28, 2020

(54) DRIVER'S EYE POSITION DETECTING DEVICE AND METHOD, IMAGING DEVICE HAVING IMAGE SENSOR WITH ROLLING SHUTTER DRIVING SYSTEM, AND ILLUMINATION CONTROL METHOD THEREOF

(71) Applicant: MTEKVISION CO., LTD., Gyeonggi-do (KR)

(72) Inventors: Se Jin KANG, Seoul (KR); Do Yeong KANG, Gyeongsangbuk-do (KR); Han Noh YOON, Seoul (KR)

(21) Appl. No.: 16/775,721

(22) Filed: Jan. 29, 2020

Related U.S. Application Data
(62) Division of application No. 16/096,504, filed on Oct. 25, 2018.

(30) Foreign Application Priority Data
May 25, 2016 (KR) 10-2016-00064189
Jun. 8, 2016 (KR) 10-2016-0070843

(51) Int. Cl. H04N 5/353; G06K 9/32; G06K 9/20; G06K 9/00; G06T 7/70; H04N 5/235; B60W 40/02; B60W 50/08; H04N 5/232

(52) U.S. Cl. CPC H04N 5/3532; G06T 2207/10048; G06K 9/2027; G06K 9/00845; G06K 9/00604; G06K 9/00228; G06T 7/70; H04N 5/2354; B60W 40/02; B60W 50/08; H04N 5/232; G06K 9/00; G06T 2207/30268; G06T 2207/30201; G06K 9/3233

(57) ABSTRACT

Driver's eye position detecting device and method are provided. The eye position detecting device includes: a light applying unit that applies light with a prescribed wavelength to the outside; a camera unit that captures an outside image and generates image information; and an image analyzing unit that generates detection result information on a face region, an eye region, and a central position of a pupil in the image information.

### CROSS REFERENCE TO RELATED APPLICATIONS

This application is a division of U.S. patent application Ser. No. 16/096,504, filed Oct. 25, 2018, which is a U.S. National Phase entry from International Application No. PCT/KR2016/007695, filed Jul. 14, 2016, claiming priority to Korean Patent Application Nos. 10-2016-0064189, filed May 25, 2016, and 10-2016-0070843, field Jun. 8, 2016, which are hereby incorporated by reference in their entirety into this application.

### BACKGROUND OF THE INVENTION

### 1. Field of the Invention

The invention relates to driver's eye position detecting device and method, an imaging device having an image sensor with a rolling shutter driving system, and an illumination control method thereof.

### 2. Description of Related Art

Various techniques for reducing the number of deaths caused by traffic accidents due to running f vehicles as much as possible have been developed. For example, a technique of capturing a face image of a driver, determining whether the driver is driving while drowsy, and outputting sound or generating vibration to attract the driver's attention when it is determined that the driver is driving while drowsy has been developed.

Particularly, Korean Patent Application Laid-Open No. 2007-0031558 discloses a technical concept that a driver's face region is imaged with a camera disposed in front of a driver seat, a face and an eye position are detected from the captured image, and it is determined whether the driver is driving while drowsy.

However, in such a related art, when a driver wears eyeglasses, there is a problem in that light reflected from the eyeglasses will be mixed with a target signal which is to be actually monitored and thus it will be difficult to sense a position or a state of an eye or a pupil.

Particularly, when light is specularly reflected from a lens surface of eyeglasses as illustrated in (a) of FIG. 1, there is also a problem in that the intensity of light which has been specularly reflected and incident on a camera may have a value greater than a signal from a detection object. In this case, depending on a difference between the intensity of light which is specularly reflected from the lens surface of eyeglasses and the magnitude of a signal which is randomly reflected from the inside of the lens, the inside of the eyeglasses is visible (see (b) of FIG. 1) or a mirror effect in which the inside of the eyeglasses is not visible (see (c) of FIG. 1) occurs.

However, when a position and a state of an eye of a driver are not detected due to the eyeglasses which are worn by the driver, an alarm cannot be given to the driver while drowsy and an accident of a vehicle may not be prevented.

As disclosed in Korean Patent Application Laid-Open No. 2015-0136746, when light is intentionally applied to image a subject, an imaging device applies light, which is stronger than ambient light, to the subject over an entire exposure time of a sensor. However, when light which is stronger than ambient light is applied from an illumination for a predetermined time, a large amount of power is consumed.

When an image sensor with a global shutter system according to the related art is used, all image pixels have the same exposure time and thus it is easy to reduce an amount of power consumed in the illumination by turning on the illumination during the exposure time of the sensor.

However, an image sensor with a rolling shutter system has sequential exposure times by lines of an image, and thus has restrictions that an amount of power consumed in the illumination cannot be reduced using the same method as in the global shutter system.

That is, as illustrated in FIG. 8, there are exposure times of 480 lines over the whole frame period in case of a VGA sensor, a state in which an illumination is turned on has to be maintained during an exposure time period of the image sensor, and the illumination has to be maintained in a normally turned-on state when continuous images are captured.

### SUMMARY OF THE INVENTION

The invention provides driver's eye position detecting device and method that can accurately detect positions of eyes and pupils of a driver wearing eyeglasses and accurately determine whether the driver is driving while drowsy.

The invention provides an imaging device having an image sensor with a rolling shutter driving system that can reduce an amount of power consumed in illumination by tracking and detecting a region of interest in each of continuous frames and adjusting an illumination turn-on section and an illumination control method thereof.

Other objectives of the invention will be easily understood from the following description.

According to an aspect of the invention, there is provided an eye position detecting device that reduces an influence of an image which is acquired from solar radiation specularly reflected from a lens surface of eyeglasses, the eye position detecting device including: a light applying unit that applies light with a prescribed wavelength to the outside; a camera unit that captures an outside image and generates image information; and an image analyzing unit that generates detection result information on a face region, an eye region, and a central position of a pupil in the image information, wherein the light with a prescribed wavelength includes light of a wavelength band of 910 nm to 990 nm, and the camera unit includes a band-pass filter that passes only light with a prescribed wavelength band in a wavelength band of 910 nm to 990 nm of the applied light and generates the image information corresponding to the applied light.

The light with the prescribed wavelength may be light with a peak wavelength of 950 nm and a centroid wavelength of 940 nm.

The camera unit may include: a lens that receives light; an image sensor that receives light passing through the band-pass filter located in a stage in the back of the lens and outputs an image signal; and a signal processing unit that generates image information corresponding to the image signal.

An installation position of the camera unit may be set to a position other than a position on which light applied by the light applying unit and specularly reflected by the eyeglasses worn by a user corresponding to a subject is incident.

According to another aspect of the invention, there is provided an imaging device having an image sensor with a rolling shutter driving system, the imaging device including: an illumination unit that illuminates a subject with light; a camera unit that includes an image sensor with a rolling shutter driving system and outputs image information generated by imaging the subject in a moving image mode; an analysis unit that detects a prescribed object of interest from an image frame constituted by the image information provided by the camera unit, sets a region of interest centered on the detected object of interest using a prescribed method, and generates region-of-interest information corresponding to the set region of interest; and a control unit that controls an operation of the camera unit by setting a camera control value and controls an operation of the illumination unit such that an illumination is turned on in only a time range corresponding to the region-of-interest information when the camera unit captures an image corresponding to a subsequent image frame.

The control unit may receive a frame synchronization signal (Vsync) and a line synchronization signal (Hsync) from the camera unit, count the input line synchronization signal, control the illumination unit such that the illumination is turned on at a start time point corresponding to the region-of-interest information, and control the illumination unit such that the illumination is turned off at an end time point corresponding to the region-of-interest information.

The camera control value may include an exposure value and a gain value of the image sensor which are set such that the image frame has prescribed average brightness.

When the illumination unit applies infrared light with a prescribed wavelength, the camera unit may include a band-pass filter that selectively passes only the infrared light with the prescribed wavelength and may generate image information based on the infrared light passing through the band-pass filter.

According to another aspect of the invention, there is provided an illumination control method for an imaging device having an image sensor with a rolling shutter driving system, the illumination control method including: (a) causing a control unit to control an operation of a camera unit which is supplied with a camera control value from the control unit and which captures a moving image of a subject with a rolling shutter driving system; (b) causing the control unit to receive a frame synchronization signal and a line synchronization signal from the camera unit, to count the input line synchronization signal, and to control an illumination unit such that an illumination is turned on only when a line synchronization signal corresponding to a preset illumination control value is being input; (c) causing an analysis unit to detect a prescribed object of interest from a current frame which is generated from image information supplied from the camera unit, to set a region of interest centered on the object of interest, and to generate region-of-interest information corresponding to the set region of interest; and (d) causing the control unit to change one or more of the camera control value and the illumination control value which are used to capture an image corresponding to a subsequent frame when the region-of-interest information generated in the step of (c) is different from the region-of-interest information on a previous frame.

The steps of (a) to (d) may be repeated when an imaging operation by the camera unit is being performed.

The illumination unit may apply infrared light with a prescribed wavelength to a subject, and the image information may be generated based on infrared light passing through a band-pass filter that selectively passes only light with the prescribed wavelength and that is disposed in the camera unit.

Other aspects, features, and advantages of the invention will become apparent from the accompanying drawings, the appended claims, and the detailed description of the invention.

### Advantageous Effects

According to an embodiment of the invention, it is possible to accurately detect positions of eyes and pupils of a driver wearing eyeglasses and to accurately determine whether the driver is driving while drowsy.

It is also possible to reduce an amount of power consumed in illumination by tracking and detecting a region of interest (for example, an eye region for detecting whether a driver is driving while drowsy) in each of continuous frames and adjusting an illumination turn-on section.

### BRIEF DESCRIPTION OF DRAWINGS

FIGS. 1a-1c are diagrams illustrating specular reflection from eyeglasses.

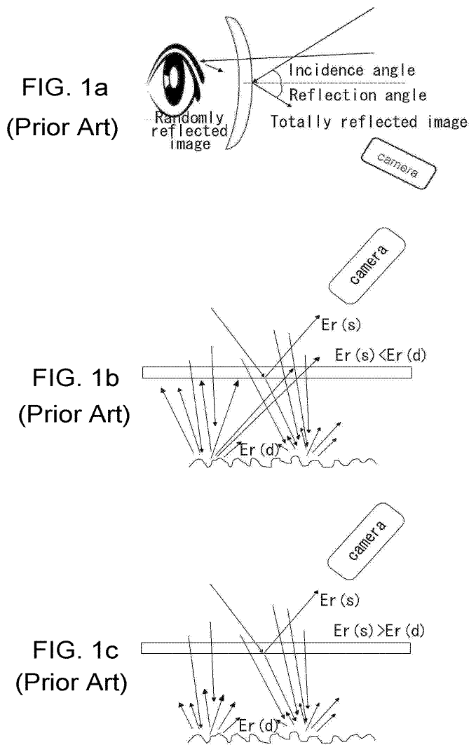

FIG. 2 is a block diagram illustrating an eye position detecting device according to an embodiment of the invention.

FIG. 3 is a block diagram illustrating a camera unit according to an embodiment of the invention.

FIG. 4 is a block diagram illustrating an image analyzing unit according to an embodiment of the invention.

FIG. 5 is a diagram illustrating a spectrum of solar radiation.

FIGS. 6a-6b are diagrams illustrating a relationship between an illumination light bandwidth of a light applying unit and a full width half maximum (FWHM) of a band-pass filter according to an embodiment of the invention.

FIG. 7 is a flowchart illustrating an eye position detecting method according to an embodiment of the invention.

FIG. 8 is a diagram illustrating illumination turn-on sections of an imaging device having an image sensor with a rolling shutter driving system according to the related art.

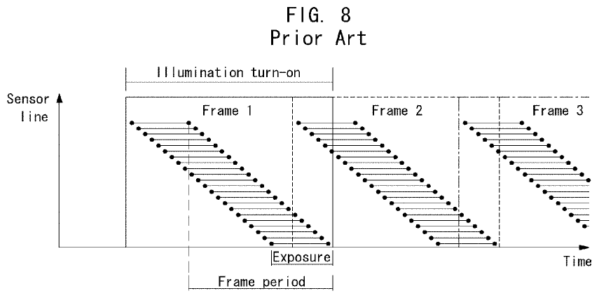

FIG. 9 is a block diagram schematically illustrating an imaging device having an image sensor with a rolling shutter driving system according to an embodiment of the invention.

FIGS. 10a-10c are diagrams illustrating a procedure of designating a region of interest in an imaging device according to an embodiment of the invention.

FIG. 11 is a diagram illustrating a captured image by illumination turn-on sections in an imaging device according to an embodiment of the invention.

FIG. 12 is a diagram illustrating an illumination control method in an imaging device according to an embodiment of the invention.

FIGS. 13a-13b are diagrams illustrating a method of changing illumination turn-on sections with change in a region of interest according to an embodiment of the invention.

### DETAILED DESCRIPTION OF THE INVENTION

The invention can be modified in various forms and specific embodiments will be described below and illustrated. However, the embodiments are not intended to limit the invention, but it should be understood that the invention includes all modifications, equivalents, and replacements belonging to the concept and the technical scope of the invention.

If it is mentioned that an element is “connected to” or “coupled to” another element, it should be understood that still another element may be interposed therebetween, as well as that the element may be connected or coupled directly to another element. On the contrary, if it is mentioned that an element is “connected directly to” or “coupled directly to” another element, it should be understood that still another element is not interposed therebetween.

The terms used in the following description are intended to merely describe specific embodiments, but not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

Terms “first,” “second,” and the like can be used to describe various elements, but the elements should not be limited to the terms. The terms are used only to distinguish an element from another.

Terms “unit”, “module”, and the like described in the specification mean a unit for performing at least one function or operation and can be embodied by hardware, by software, or by a combination of hardware and software.

Elements of an embodiment described below with reference to the accompanying drawings are not limited to the corresponding embodiment, may be included in another embodiment without departing from the technical spirit of the invention. Although particular description is not made, plural embodiments may be embodied as one embodiment.

In describing the invention with reference to the accompanying drawings, like elements are referenced by like reference numerals or signs regardless of the drawing numbers and description thereof is not repeated. When it is determined that detailed description of known techniques involved in the invention makes the gist of the invention obscure, the detailed description thereof will not be made.

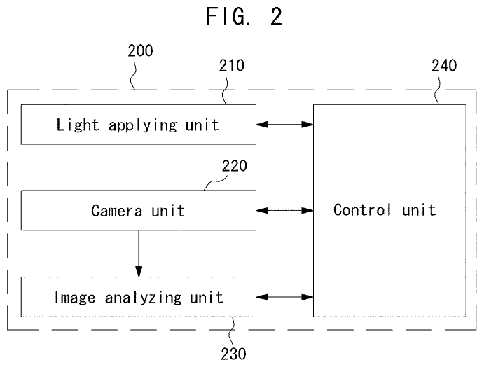

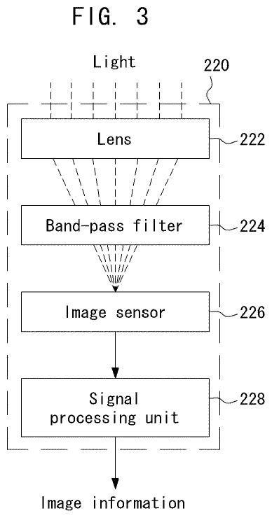

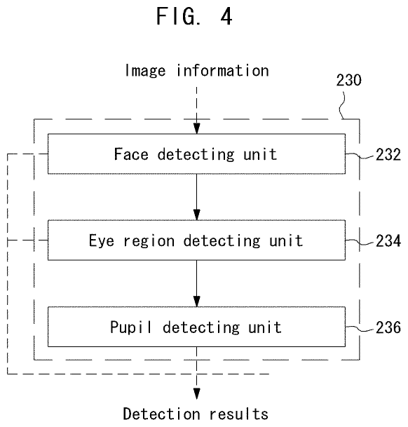

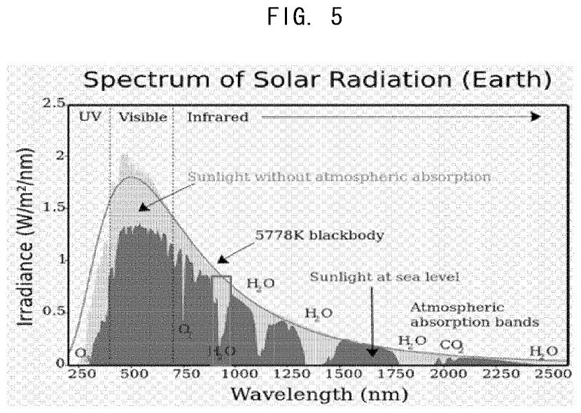

FIG. 2 is a block diagram illustrating an eye position detecting device according to an embodiment of the invention. FIG. 3 is a block diagram illustrating a camera unit according to an embodiment of the invention. FIG. 4 is a block diagram illustrating an image analyzing unit according to an embodiment of the invention. FIG. 5 is a diagram illustrating a spectrum of solar radiation.

Referring to FIG. 2, an eye position detecting device 200 includes a light applying unit 210, a camera unit 220, an image analyzing unit 230, and a control unit 240. The eye position detecting device 200 is attached to an appropriate position in a vehicle (for example, a position around a rear-view mirror or one side of a dashboard) such that a face image of a driver can be effectively secured.

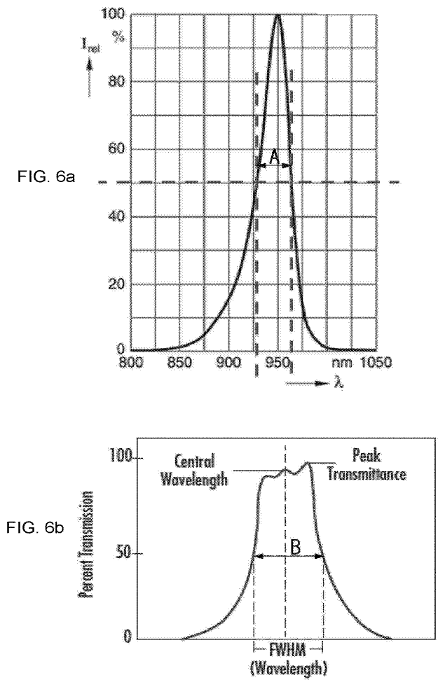

The light applying unit 210 applies light in a prescribed wavelength band to the outside. The light in the prescribed wavelength band which is applied from the light applying unit 210 includes light in a wavelength band with a wavelength range of 910 nm to 990 nm as illustrated in (a) of FIG. 6, where a peak wavelength thereof is set to 950 nm and a centroid wavelength (that is, a wavelength corresponding to the center of gravity which partitions the area of a graph into halves) thereof is set to 940 nm.

In the following description, light applied from the light applying unit 210 is referred to as 940 nm light, and a specific wavelength band of which light is selectively passed by a band-pass filter 224 (see FIG. 3) which will be described later is referred to as a 940 nm band.

As illustrated in FIG. 5, an optical spectrum of a 940 nm band from the spectrum of solar radiation is much absorbed by H2O in the air and the magnitude of an optical signal in the 940 nm band based on solar radiation is relatively small.

The eye position detecting device 200 according to this embodiment includes the light applying unit 210. Accordingly, even when solar radiation and a subject image generated by the solar radiation (which includes ambient light) is specularly reflected from a lens surface of eyeglasses and is input to the camera unit 220, light other than the light in the 940 nm band is removed by the band-pass filter 224 included in the camera unit 220 and thus an influence of a reflected light signal is minimized.

The camera unit 220 generates image information of a region including a face of a driver. An installation position of the camera unit 220 can be set to a position other than a position of a reflection angle at which light applied from the light applying unit 210 is specularly reflected from the eyeglasses or the like.

Referring to FIG. 3, the camera unit 220 includes a lens (222), a band-pass filter 224, an image sensor 226, and a signal processing unit 228.

That is, in the camera unit 220, light input through the lens 222 passes through the band-pass filter 224 and is accumulated as electric charges in the pixels of the image sensor 226, an image signal output from the image sensor 226 is processed into image information by the signal processing unit 228, and the image information processed by the signal processing unit 228 is supplied to the image analyzing unit 230. For example, the signal processing unit 228 may be an image signal processor (ISP).

In (a) of FIG. 6, a graph associated with light intensity relative to a wavelength (λ) of light applied from the light applying unit 210 according to this embodiment is illustrated. In this embodiment, light applied from the light applying unit 210 which is referred to as 940 nm light includes light of a wavelength band of 910 nm to 990 nm, where a peak wavelength is 950 nm and a centroid wavelength is 940 nm.

This is because the magnitude of an optical signal in 940 nm based on solar radiation is relatively small and thus an influence of an image which is generated by specular reflection of solar radiation from a lens surface of eyeglasses can be satisfactorily reduced by the light applying unit 210 that applies light in the band.

Accordingly, when a bandwidth corresponding to 50% of light intensity at 950 nm which is the peak wavelength is defined as A, the full width half maximum (FWHM) B of the band-pass filter 224 can be set to substantially equal to the value of A as illustrated in (b) of FIG. 6.

When B is excessively greater than A, light in a band other than the 940 nm band is also input to the image sensor 226 and thus selection of the 940 nm band in which an amount of solar radiation is the smallest is meaningless. When B is excessively smaller than A, light in an appropriate wavelength band can be input, but an amount of input light is excessively small and the image sensor 226 does not operate appropriately. Accordingly, A and B need to be set to substantially the same magnitude, that is, the same magnitude or magnitudes having a difference less than a prescribed error range.

Referring to FIG. 3, the camera unit 220 has the same configuration as an existing camera unit including a lens, an image sensor, and a signal processing unit except that the band-pass filter 224 is provided to filter input light and thus detailed description thereof will not be repeated.

Referring to FIG. 4, the image analyzing unit 230 includes a face detecting unit 232, an eye region detecting unit 234, and a pupil detecting unit 236.

The face detecting unit 232 detects a face region from image information input from the camera unit 220. In order to detect a face region, for example, an Adaboost algorithm using a plurality of Harr classifiers in combination can be used. For example, a region in a color range which is designated in advance as a skin color may be detected as a face region. Various detection methods for detecting a face region from image information may further used.

The eye region detecting unit 234 detects an eye region in the face region detected by the face detecting unit 232. A range of an eye region in which an eye is located in the face region detected by the face detecting unit 232 may be designated in advance, for example, as an upper 30% region of the detected face region in consideration of a face position of a driver sitting in the vehicle and an installation angle of the camera unit 220. The eye region detecting unit 234 may designate an eye region as a result of learning for a region which is mainly recognized as a region in which a pupil is present by the pupil detecting unit 236 in previous processes.

The pupil detecting unit 236 detects the center of a pupil in the detected eye region. The center of a pupil can be detected in the eye region, for example, using an adaptive threshold estimating method using features that a gray scale of a pupil region is lower than that of the other region. For example, a method of detecting a motion vector using a hierarchical KLT feature tracking algorithm and extracting accurate central coordinates of a pupil using the detected motion vector can also be used.

Even when a face of a driver imaged by the camera unit 220 through the above-mentioned processes is a front face or is not a front face, a face region, an eye region, and presence and a position of a pupil can be accurately detected.

The image analyzing unit 230 supplies one or more of face region information, eye region information, and pupil central position information as detection results to the control unit 240.

When the pupil central position information is not continuously input from the image analyzing unit 230 for a predetermined time (for example, 0.5 seconds) or more (for example, when a state in which an eye is closed and a pupil is not detected is maintained), the control unit 240 can recognize that the driver is driving while drowsy. When the driver is recognized to be drowsy, the control unit 240 causes a speaker (not illustrated) to output sound or attracts the driver's attention by causing a steering wheel gripped by the driver to vibrate or the like.

The control unit 240 can control the operations of the light applying unit 210, the camera unit 220, and the image analyzing unit 230.

As described above, the eye position detecting device 200 according to this embodiment is characterized in that it can be embodied such that the magnitude of a signal from the surface of a detection object from which light is randomly reflected is larger than the intensity of light which is incident from the outside and specularly reflected from a lens surface of eyeglasses and a position and a state of the detection object can be effectively acquired regardless of light which is specularly reflected from a glass medium such as eyeglasses and is incident.

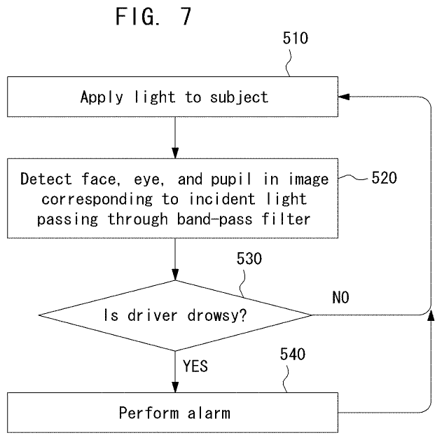

FIG. 7 is a flowchart illustrating an eye position detecting method according to an embodiment of the invention.

Referring to FIG. 7, the light applying unit 210 applies 940 nm light to a driver in step 510. The light applying unit 210 is controlled by the control unit 240 such that it is turned on/off in accordance with a prescribed light application period.

In Step 520, the camera unit 220 including the band-pass filter 224 generates image information based on an optical signal which is filtered by the band-pass filter 224 among optical signals input through the lens 222.

The image analyzing unit 230 detects a face region, an eye region, and a pupil from the image information generated by the camera unit 220 and generates face region information, eye region information, and pupil center position information.

In Step 530, the control unit 240 determines whether the driver is driving while drowsy depending on whether the pupil center position information generated in Step 520 is not continuously input from the image analyzing unit 230, for example, for a predetermined time (for example, 0.5 seconds) or more.

When it is determined the driver is drowsy, the control unit 240 performs a predetermined alarming process to attract the driver's attention in Step 540. The alarming process may be, for example, a process of outputting sound from a speaker (not illustrated) or a process of causing a steering wheel gripped by the driver to vibrate.

While an embodiment in which an eye region and a pupil of a driver getting on a vehicle are detected to prevent of driving while drowsy has been described above, the eye position detecting device and method according to the invention can be applied to various fields in which a position of an eye needs to be detected such as iris scan.

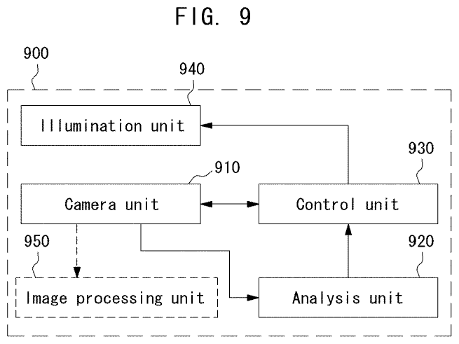

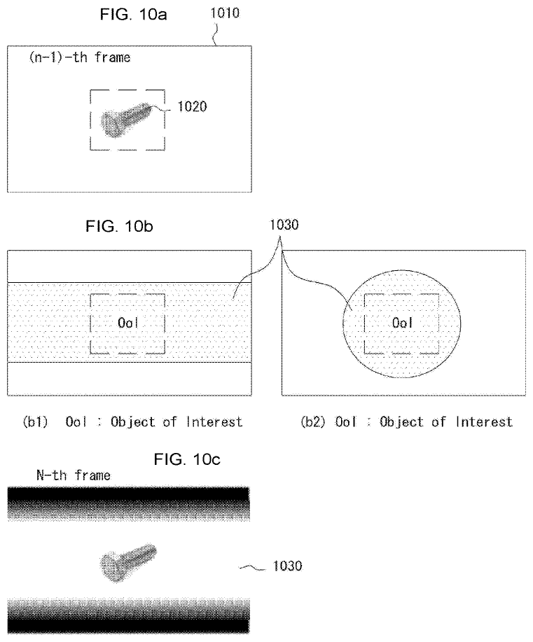

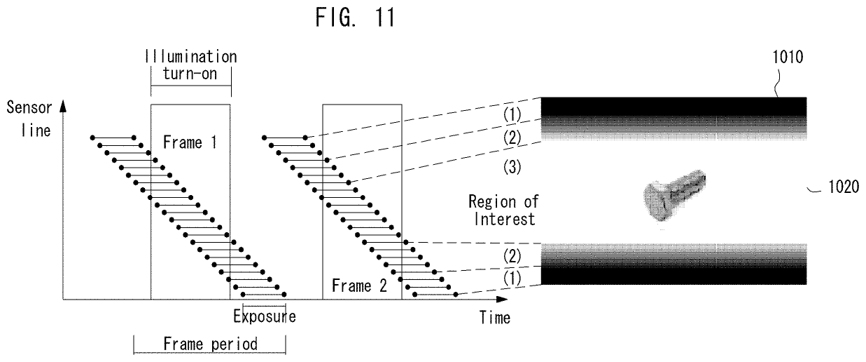

FIG. 9 is a block diagram schematically illustrating a configuration of the imaging device including an image sensor with a rolling shutter driving system according to an embodiment of the invention. FIG. 10 is a diagram illustrating a process of designating a region of interest in the imaging device according to the embodiment of the invention. FIG. 11 is a diagram illustrating images captured in illumination turn-on sections by the imaging device according to the embodiment of the invention.

Referring to FIG. 9, the imaging device 900 includes a camera unit 910, an analysis unit 920, a control unit 930, and an illumination unit 940. The analysis unit 920 may be provided as a part of the control unit 930, but has an independent configuration in this embodiment for the purpose of convenience. The analysis unit 920, the illumination unit 940, the camera unit 910, and the control unit 930 may be the same elements as the image analyzing unit 230, the light applying unit 210, the camera unit 220, and the control unit 240 which have been described above, or may be elements which are additionally provided.

When an image captured by the camera unit 910 is processed and is output via a display device (not illustrated) or when an image is analyzed and determination matching a predetermined purpose (for example, imaging of a driver's face, detecting of an eye region, and determination of whether the driver is driving while drowsy) is performed, the imaging device 900 may further include an image processing unit 950 as illustrated in the drawings.

The camera unit 910 includes an image sensor with a rolling shutter driving system and an image signal processor (ISP). The camera unit 910 images a subject based on a camera control value (that is, an exposure value and/or a gain value of the image sensor) which is supplied from the control unit 930, and provides a frame synchronization signal Vsync and a line synchronization signal Hsync corresponding to the captured image to the control unit 930. The camera unit 930 supplies image information corresponding to the image captured based on the camera control value to the analysis unit 920 for the purpose of determination of a region of interest.

The analysis unit 920 generates region-of-interest information (for example, coordinate section information designated in one frame) using the image information supplied from the camera unit 910, that is, image information corresponding to a specific frame, and supplies the generated region-of-interest information to the control unit 930.

As illustrated in FIG. 10, the region-of-interest information for defining a region of interest 1030 can be generated, for example, to correspond to one or more of a shape, a size, and a position of a prescribed object of interest 1030. Information on one or more of the shape, the size, and the position of the object of interest 1030 may be stored in a storage unit (not illustrated) in advance.

For example, the region-of-interest information in an n-th frame is based on one or more of the shape, the size, and the position of an object of interest 1020 stored in advance in the storage unit (not illustrated), and can be set based on the position of the object of interest 1020 detected in the (n−1)-th frame by applying a tracking algorithm such as a Kalman filter or a particle filter to the (n−1)-th frame based on the position of the object of interest 1020 in the (n−2)-th frame or performing edge detection for detecting the object of interest 1020 (see (a) and (c) of FIG. 10). For example, a machine learning algorithm such as boosting, SVM, or an artificial neural network may be used to detect the object of interest 1020, and an Adaboost algorithm or the like may be further used when the imaging device 900 according to this embodiment is used to check a driver's pupil for the purpose of determination of whether the driver is driving while drowsy.

As illustrated in (b) of FIG. 10, a region of interest 1030 may be designated, for example, as a vertical line with a predetermined length with respect to the object of interest 1020 (see (b1) of FIG. 10) or may be designated as a circular region with a predetermined radius centered on the center point of the object of interest 1020 (see (b2) of FIG. 10). In this way, the region-of-interest information which is applied to a subsequent frame can be updated by the analysis unit 920 that performs a process of detecting an object of interest 1020 in a previous and/or current frame.

When a predetermined time is required for position analysis of the object of interest 1020 and setting of the region of interest 1030, a time delay such as application of region-of-interest information set by analysis of an (n−3)-th frame to the n-th frame may occur due to technical or productional restrictions. However, these technical restrictions do not limit the technical concept of the invention that the region-of-interest information designated by analysis of a previous frame among continuous frames is used as information for illumination control at the time of imaging a subsequent frame.

As described above, updated region-of-interest information can contribute to reduction in power consumption and improvement in image processing speed based on limiting of illumination sections.

That is, when an image processing unit 950 which will be described later performs prescribed determination, any particular image processing and determination are not performed on a region other than the region of interest designated by the region-of-interest information. Accordingly, it is possible to improve an image processing speed per frame. For example, when the imaging device 900 according to this embodiment captures a face image of a driver for the purpose of determination of whether the driver is driving while drowsy, a region of interest 1030 is designated centered on an object of region 1030 which is a driver's eye region or pupil. Accordingly, it is possible to reduce an image processing load in the image processing unit 950 and thus to reduce the image processing speed and the time required for determination of whether a driver is driving while drowsy.

Newly generated region-of-interest information is supplied to the control unit 930 and can be used as basis information for illumination section control of the illumination unit 940 at the time of imaging a subsequent frame. Accordingly, it is possible to reduce power consumption in an illumination. This is because illumination light does not need to be applied at the time of imaging a region other than the region of interest 1030 and thus sections in which an illumination is turned on can be reduced.

Here, when the camera unit can output image data at a higher frame rate than a frame rate of a necessary image, it is possible to further reduce power consumption by turning on an illumination to skip some of frames of input images.

The control unit 930 maintains or changes a camera control value (that is, an exposure value and a gain value of the image sensor which are set to acquire an image with average brightness) for the camera unit 910 with reference to the region-of-interest information supplied from the analysis unit 920, and sets an illumination control value (that is, an Hsync count value) corresponding to the illumination turn-on sections corresponding to the region of interest 1030.

That is, the control unit 930 sets an illumination control value for a subsequent frame based on the region-of-interest information which is analyzed based on the image information of a current frame captured using the camera control value by analysis unit 920. Thereafter, the control unit recognizes start of a subsequent frame based on the frame synchronization signal Vsync input from the camera unit 910, counts the line synchronization signal Hsync input from the camera unit 910, inputs an illumination turn-on trigger signal to the illumination unit 940 when it is determined that it is an exposure time of a line corresponding to the illumination control value, that is, the region of interest, and inputs an illumination turn-off trigger signal to the illumination unit 940 when it is determined that it is not the exposure time of the line corresponding to the region of interest.

The control unit 930 can update and set a drive setting value (that is, the camera control value and the illumination control value) such as adjusting an exposure time or adjusting an illumination turn-on section based on the region-of-interest information updated to correspond to position change of the object of interest 1020 in continuous image frames.

The illumination unit 940 applies light to a subject and turns on or off an illumination based on the illumination turn-on/off trigger signal from the control unit 930.

The illumination unit 940 can be configured, for example, to apply infrared light in a prescribed wavelength band to a subject. In this case, by providing the camera unit 910 with a band-pass filter that selectively passes only infrared light with a prescribed wavelength, it is possible to reduce an influence of solar radiation in detecting an object of interest and determining whether a driver is driving while drowsy using a captured image.

FIG. 11 illustrates an image captured by the camera unit 910 in a state in which the illumination unit 940 turns on and off the illumination under the control of the control unit 930. As illustrated in the drawing, since a degree of definition of an image varies depending on an amount of light input during an exposure time of each section (for example, each line) in one frame, for example, section (2) is processed to be brighter than section (1), the control unit 930 can control the operation of the illumination unit 940 such that the entire section designated as the region of interest 1030 is set to the exposure time. When the exposure time of the image sensor increases at the same illumination control value, section (1) decreases and section (2) increases. When the turn-on section increases at the same camera control value, section (3) increases and sections (1) and (2) decrease.

In this way, by performing an illumination turning-on process on only the region of interest 1030 in one frame, it is possible to reduce power consumption in comparison with a conventional case in which the camera unit 910 includes an image sensor with a rolling shutter driving system and an illumination turning-on process is required over the entire frame.

For example, when the imaging device 900 is installed in a vehicle and is used to capture a face image of a driver for determining whether the driver is driving while drowsy, a region other than an eye region or a pupil of the driver is a region not requiring processing or determination and thus illumination control and image processing can be concentrated on the region of interest 1030. Accordingly, it is possible to perform fast image processing and determination with reduced power consumption.

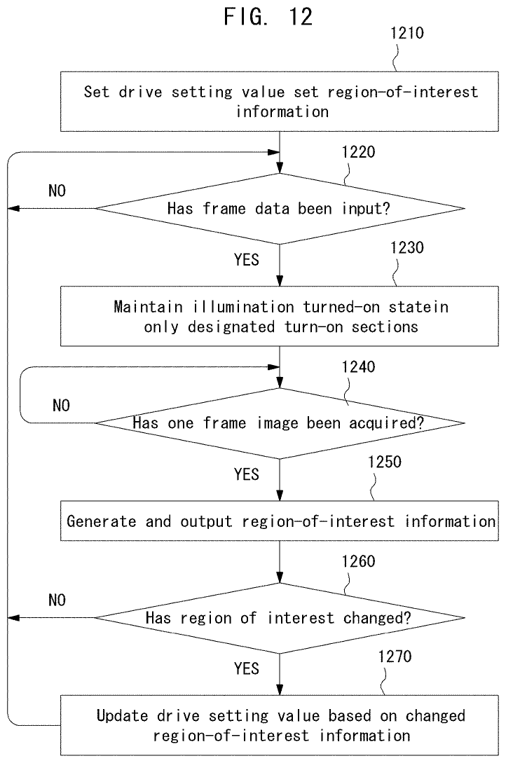

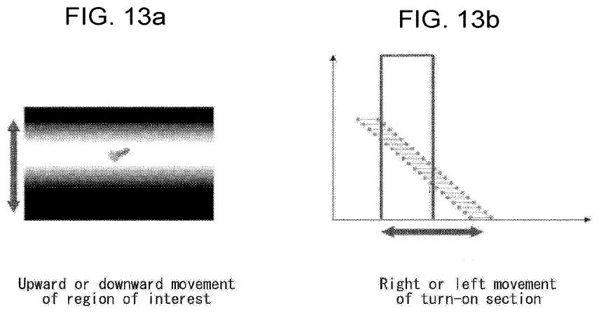

FIG. 12 is a flowchart illustrating an illumination control method in an imaging device according to an embodiment of the invention. FIG. 13 is a diagram illustrating a method of changing an illumination turn-on section due to change of a region of interest according to an embodiment of the invention.

Referring to FIG. 12, in Step 1210, the control unit 930 designates a drive setting value corresponding to region-of-interest information which is currently set. The drive setting values is one or more of an exposure value and a gain value of the image sensor, and may be a camera control value supplied to the camera unit 910 and an illumination control value for controlling the operation of the illumination unit 940 to designate an illumination turn-on/off section.

In Step 1220, the control unit 930 determines whether inputting of new image frame data has been started. The control unit 930 can recognize starting of new image frame data, for example, based on a frame synchronization signal Vsync input from the camera unit 910.

When inputting of new image frame data has not been started, the process of Step 1220 is repeated. However, when new image frame data is input, the control unit 930 refers to the designated illumination control value, counts a line synchronization signal Hsync input from the camera unit 910, controls the illumination unit 940 such that it is turned on when it is determined that it is an exposure time for a line corresponding to the region of interest 1030, and controls the illumination unit 940 such that it is turned off when it is determined that it is not the exposure time for the line corresponding to the region of interest 1030.

In Step 1240, the analysis unit 920 determines whether all of image information corresponding to one frame has been supplied from the camera unit 910. When the received image information does not correspond to one frame, the process flow is repeated until all of image information corresponding to one frame is input.

On the other hand, when all of image information corresponding to one frame has been input, the analysis unit 920 detects an object of interest 1020 in one frame input from the analysis unit 920, sets a region of interest 1030 using a prescribed method based on the position of the detected object of interest 1020, and inputs the set region-of-interest information (for example, coordinate information) to the control unit 930. When the region-of-interest information is kept equal to the previous frame, inputting of the region-of-interest information to the control unit 930 may be omitted.

As described above with reference to FIG. 10, a region of interest in a current frame can be set to have prescribed size and shape based on a position of an object of interest 1020 detected in a preceding (that is, immediately previous or previous) frame using one or more of a position tracking algorithm and an object edge detection algorithm based on the shape, the size, and the position of the object of interest 1020 stored in the storage unit (not illustrated).

As described above, the region of interest 1030 can be updated with change in the position and/or size of the object of interest 1020 imaged in a previous frame and a current frame.

For example, as illustrated in (a) of FIG. 13, when the analysis unit 920 determines that the object of interest 1020 has moves upward or downward, the analysis unit 920 generate region-of-interest information indicating that the region of interest 1030 has moved upward or downward and supply the generated region-of-interest information to the control unit 930. The control unit 930 can increase or decrease the illumination control value for controlling the turn-on section of the illumination unit 940.

In addition, when the size of the object of interest 1020 decreases and the region of interest is relatively narrowed, the control unit 930 can update the camera control value such that the exposure value of the image sensor increases (that is, the exposure time increases) and the gain thereof decreases, or update the illumination control value such that the turn-on section decreases as illustrated in section (2) in FIG. 11. When the gain value decreases, it is possible to improve image quality. When the size of the object of interest 1020 increases and the region of interest is relatively widened, the control unit may update the camera control value such that the exposure time decreases to acquire good image quality even in a short turn-on section or update the illumination control vale such that the turn-on time increases.

Referring to FIG. 12, the control unit 930 determines whether the region-of-interest information has changed in Step 1260. When the region-of-interest information has not changed, the control unit 930 performs the above-mentioned process using the previously applied driving setting value in Step S1220.

On the other hand, when the region-of-interest information has changed, the control unit 930 updates the drive setting value to correspond to the changed region of interest in Step 1270 and performs the above-mentioned process based on the updated drive setting value in Step S1220.

The eye position detecting method and/or the illumination control method may be embodied as automated procedures based on the time-series order by a software program incorporated into a digital processor. Codes and code segments of the program will be easily inferred by computer programmers skilled in the art.

The program can be stored in a computer-readable recording medium and can be read and executed by a digital processor to embody the above-mentioned methods. The recording medium includes a magnetic recording medium, an optical recording medium, and a carrier wave medium.

While the invention has been described above with reference to exemplary embodiments, it will be understood by those skilled in the art that the invention can be modified and changed in various forms without departing from the concept and scope of the invention described in the appended claims.

What is claimed is:

1. An eye position detecting device that reduces an influence of an image which is acquired from solar radiation specularly reflected from a lens surface of eyeglasses, the eye position detecting device comprising:
a light applying unit that applies light with a prescribed wavelength to the outside;
a camera unit that captures an outside image and generates image information; and
an image analyzing unit that generates detection result information on a face region, an eye region, and a central position of a pupil in the image information,
wherein the light with a prescribed wavelength includes light of a wavelength band of 910 nm to 990 nm, and
wherein the camera unit includes a band-pass filter that passes only light with a prescribed wavelength band in a wavelength band of 910 nm to 990 nm of the applied light and generates the image information corresponding to the applied light.

2. The eye position detecting device according to claim 1, wherein the light with the prescribed wavelength is light with a centroid wavelength of 940 nm.

3. The eye position detecting device according to claim 1, wherein the camera unit includes:
a lens that receives light;
an image sensor that receives light passing through the band-pass filter located in a stage in the back of the lens and outputs an image signal; and
a signal processing unit that generates image information corresponding to the image signal.

4. The eye position detecting device according to claim 1, wherein an installation position of the camera unit is set to a position other than a position on which light applied by the light applying unit and specularly reflected by the eyeglasses worn by a user corresponding to a subject is incident.
